(19) United States
(12) Patent Application Publication
(10) Pub. No.: US 2024/0394202 A1
(43) Pub. Date: Nov. 28, 2024

(54) APPARATUSES AND METHODS FOR CONTROLLING MEMORY TIMING PARAMETERS

(71) Applicant: Analog Devices International Unlimited Company, Limerick (IE)

(72) Inventors: Thirukumaran NATRAYAN, Bangalore (IN); Kaushik KANDUKURI, Bangalore (IN)

(21) Appl. No.: 18/670,399

(22) Filed: May 21, 2024

(30) Foreign Application Priority Data
May 26, 2023 (IN) 202341036460

(51) Int. Cl. G06F 13/16; G06F 1/08; G06F 13/42

(52) U.S. Cl. CPC G06F 13/1689; G06F 1/08; G06F 13/4217

(57) ABSTRACT

Aspects of the present disclosure include a memory circuit including a timing circuit including a flip-flop configured to receive a clock signal having a first frequency and output an intermediate clock signal having a second frequency that is a fraction of the first frequency, a multiplexer configured to receive the clock signal and the intermediate clock signal, receive a selection signal indicating a selection of the clock signal or the intermediate clock signal, and output one of the clock signal or the intermediate clock signal based on the selection signal, and a memory controller configured to be read via a first interface synchronized to the clock signal at the first frequency, and programmed via a second interface synchronized to the intermediate clock signal at the second frequency.

### CROSS-REFERENCE TO RELATED APPLICATIONS

The current application claims priority to, and the benefit of, India Provisional Patent Application No. 20/234,1036460 filed May 26, 2023 and entitled “APPARATUSES AND METHODS FOR CONTROLLING MEMORY TIMING PARAMETERS,” the contents of which are hereby incorporated by reference in their entireties.

### BACKGROUND

In many electronic devices, a memory device is used to store computer instructions and/or data. For example, a memory device may be used as disk cache, write buffer, or permanent storage. Each memory device may be configured to be written (programmed) and/or read. The interfaces for programming and for reading may be different. The differences in the interfaces may requiring the programming operations and the reading operations to be implemented differently. Therefore, improvements are desirable.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Aspects of the present disclosure include a memory circuit including a timing circuit including a flip-flop configured to receive a clock signal having a first frequency and output an intermediate clock signal having a second frequency that is a fraction of the first frequency, a multiplexer configured to receive the clock signal and the intermediate clock signal, receive a selection signal indicating a selection of the clock signal or the intermediate clock signal, and output one of the clock signal or the intermediate clock signal based on the selection signal, and a memory controller configured to be read via a first interface synchronized to the clock signal at the first frequency, and programmed via a second interface synchronized to the intermediate clock signal at the second frequency.

Aspects of the present disclosure include a timing circuit configured to generate an internal clock signal having an internal clock frequency, a modulator configured to adjust a pulse width of the internal clock signal to generate a first clock signal having a first frequency, wherein the first frequency is a fraction of the internal clock frequency, and a memory controller configured to be: read via a first interface synchronized to the internal clock signal at the internal clock frequency, and programmed via a second interface synchronized to the first clock signal at the first frequency.

Aspects of the present disclosure include a method of operating a memory controller including generating a first clock signal having a first frequency, generating a second clock signal having a second frequency, wherein the second frequency is a fraction of the first frequency, and reading memory of the memory controller via a first interface synchronized to the first clock signal at the first frequency, or programming the memory of the memory controller via a second interface synchronized to the second clock signal at the second frequency.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates a first example of a memory circuit, including an inset having example clock waveforms, according to aspects of the present disclosure.

FIG. 2 illustrates a second example of the memory circuit, including an inset having example clock waveforms, according to aspects of the present disclosure.

FIG. 3 illustrates an example of a controller according to some aspects of the present disclosure.

FIG. 4 illustrates an example of a method for operating a memory circuit at two frequencies according to aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

A One Time Programmable memory controller (OTPC) may be designed for building robust security features for computing devices, such as but not limited to digital signal processor (DSP) using silicon-on-chip (SoC) technologies. OTPC may be implemented to store important information such as lock, customer keys, etc. Integration of an OTPC module may be implemented by taking the design deliverables from third parties (e.g., vendors, customers, etc.). On top of the design delivered from the third parties, the OTPC module may be designed to support an Advanced extensible Interface (AXI) and/or an Advanced Peripheral Bus (APB) interface along with security features to support various system requirements. It has been observed that, at some process nodes (e.g., 22 nanometer (nm)), OTPC designs require lower memory frequency during the non-volatile memory (NVM) programming process (which may be due to various limitations), but can support higher frequency during the NVM memory reading process. Aspects of the present disclosure include controllers that would satisfy two different timing requirements in two different modes, and thus, can support the most optimal system performance. Other aspects ensure backward compatibility and support NVM memory at different process nodes.

In one aspect of the present disclosure, an one-time programmable (OTP) memory may be accessed through two interfaces: one for the programming phase and the other for the reading phase. A dynamic clock modulator may be implemented to operate at a first frequency for the programming phase, and may deliver a first clock signal at the first frequency to the controller/interface managing the programming operation. The dynamic clock modulator may also be implemented to operate at a second frequency for the reading phase, and may deliver a second clock signal at the second frequency to the controller/interface managing the reading operation. Some aspects of the present disclosure may include the dynamic clock modulator toggling between the two controllers either automatically, or user driven. In some aspects, a clock modulator circuit may deliver the optimal frequency to the respective controllers in their activity phases via clock division and/or clock selection.

A first aspect of the present disclosure includes varying the pulse width of the clock to the memory with the use of register settings. This will satisfy both clock pulse width requirements and/or read recovery time requirements (i.e., time to sample the read data from memory after the clock negative/falling edge). The register settings may make the user interface independent of the frequency change. For example, the widths of a high time (HT) and/or a low time (LT) of the clock to memory may be varied. High time may be controlled by a HT bit field (e.g., [(HT+1) pulses]), which defines the clock pulse width, and low time may be controlled by a LT bit field (e.g., [(LT+1) pulses]), which defines the sample edge of the read data.

A second aspect of the present disclosure includes controlling the incoming clock to an one-time programmable memory controller (OPTC) module from one or more frequency select register of the OTPC module. Access to the APB interface for the programming operation may be performed at a lower frequency. Access to the AXI interface for the reading operation may be performed at a higher frequency.

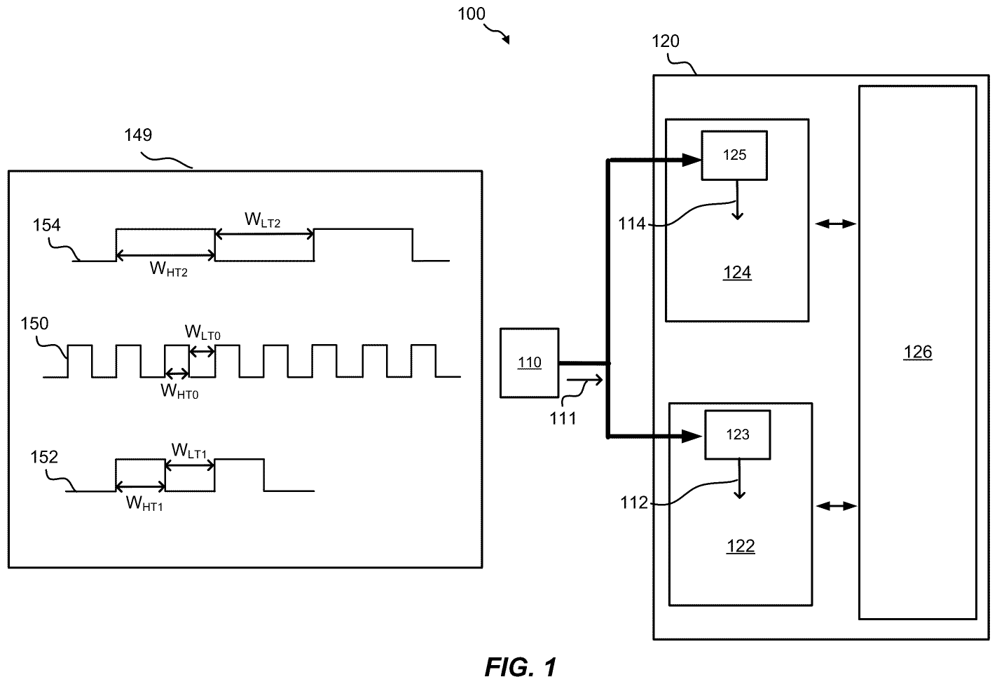

FIG. 1 illustrates an example of a memory circuit 100 according to aspects of the present disclosure. The memory circuit 100 includes a timing circuit 110 configured to generate an internal clock signal 111 use in controlling memory access. The memory circuit 100 also includes a memory controller 120 having a reading interface 122 configured to read (output information (control and/or data) from a memory device 126, and a programming interface 124 configured to program (input) information (control and/or data) onto the memory device 126. The reading interface 122 may include a first modulator 123 configured to modulate an internal clock signal 111 into a first clock signal 112 having a first frequency. The programming interface 124 may include a second modulator 125 configured to modulate the internal clock signal 111 into a second clock signal 114 having a second frequency. The memory device 126 may include, but is not limited to one or more of one time programmable memory, flash memory, solid state memory, magnetic memory, field programmable gate array (FPGA), programmable logic array (PLA), random access memory (RAM), read only memory (ROM), and/or other non-volatile or volatile memories.

In certain aspects, the reading interface 122 and/or the programming interface 124 may be implemented as an AXI and/or an APB interface. Other types of interface architectures may also be implemented according to aspects of the present disclosure.

In some aspects of the present disclosure, the reading phase/operation may be implemented at the first frequency of the first clock signal 112 via the reading interface 122. The programming phase/operation may be implemented at the second frequency second clock signal 114 via the programming interface 124. In an example, the first frequency may be lower than the second frequency, for example, 90%, 75%, 50%, 25% or some other fraction of the second frequency. As such, the programming operation may operate at a lower frequency than the reading operation. Consequently, the programming operation may not be operating at the optimum operational frequency of the reading operation.

In some aspects of the present disclosure, the timing circuit 110, the first modulator 123, and/or the second modulator 125 may selectively control read and programming operations. For instance, the timing circuit 110 and/or the first modulator 123 may generate the first clock signal 112 for the reading interface 122, which is synchronized to the first clock signal 112, to control read operations. Similarly, the timing circuit 110 and/or the second modulator 125 may generate the second clock signal 114 to the programming interface 124, which is synchronized to the second clock signal 114, to control programming operations. The timing circuit 110 may be a standalone device or integrated into the memory controller 120.

In certain aspects of the present disclosure, referring to the inset 149 of example clock waveforms, the timing circuit 110 may be configured to operate an internal clock signal 111 having an internal clock waveform 150. For example, the internal clock waveform 150 may have an internal high time pulse width (W_{HT0}) and an internal low time pulse width (W_{LT0}). The first modulator 123 may be configured to modulate the W_{HT0} and/or the W_{LT0} of the internal clock waveform 150 to generate the first clock signal 112. The first clock signal 112 may have a first clock waveform 152 having a first high time pulse width (W_{HT1}) and a first low time pulse width (W_{LT1}). Similarly, the second modulator 125 may be configured to modulate the W_{HT0} and/or the W_{LT0} to generate the second clock signal 114. The second clock signal 114 may have a second clock waveform 154 having a second high time pulse width (W_{HT2}) and a second low time pulse width (W_{LT2}).

During operation, in one aspect of the present disclosure, the timing circuit 110 may generate the internal clock signal 111. The first modulator 123 may modulate the W_{HT0} and/or the W_{LT0} of the internal clock waveform 150 to generate the first clock signal 112. For example, the first modulator 123 may widen the W_{HT0} and the W_{LT0} of the internal clock waveform 150 to generate the first clock signal 112 having the first clock waveform 152. Specifically, the first modulator 123 may widen the W_{HT0} and the W_{LT0} into the W_{HT1} and the W_{LT1}, respectively to generate the first clock waveform 152. In some instances, the W_{HT1} may be twice the width of the W_{HT0}, and the W_{LT1} may be twice the width of the W_{LT0}. As such, the first frequency of the first clock signal 112 is “effectively” half of the frequency of the internal clock waveform 150. Consequently, the timing circuit 110, the first modulator 123, and/or the second modulator 125 are able to collectively output two separate clock signals with different clock frequencies by changing the widths of the waves.

In some aspects of the present disclosure, the second modulator 125 may modulate the W_{HT0} and/or the W_{LT0} of the internal clock waveform 150 to generate the second clock signal 114. For example, the second modulator 125 may widen the W_{HT0} and the W_{LT0} of the internal clock waveform 150 to generate the second clock signal 114 having the second clock waveform 154. Specifically, the second modulator 125 may widen the W_{HT0} and the W_{LT0} into the W_{HT2} and the W_{LT2}, respectively to generate the second clock waveform 154. In some instances, the W_{HT2} may be four times the width of the W_{HT0}, and the W_{LT2} may be four times the width of the W_{LT0}. As such, the first frequency of the second clock signal 114 is “effectively” one-fourth of the frequency of the internal clock waveform 150.

In certain aspects of the present disclosure, the reading interface 122 may use the first clock signal 112 to synchronize, at the first frequency, any reading operation that outputs information from the memory device 126. In some aspects of the disclosure, the memory controller 120 and/or the reading interface 122 may synchronize the reading operation by sampling the rising edge and/or the falling edge of the first clock waveform 152 of the first clock signal 112.

In certain aspects of the present disclosure, the programming interface 124 may use the second clock signal 114 to synchronize, at the second frequency, any programming operation that inputs information into the memory device 126. In some aspects of the disclosure, the memory controller 120 and/or the programming interface 124 may synchronize the reading operation by sampling the rising edge and/or the falling edge of the second clock waveform 154 of the second clock signal 114.

An advantage associated with the implementation above allows for the generation of two clock signals with two different frequencies using a single source. As such, the reading interface 122 may operate at its optimum frequency without requiring additional input clock signals.

In one aspect of the present disclosure, a single modulator may be implemented, for example, the programming interface 124. The reading interface 122 may operate using the internal clock signal 111 without modulation. The second modulator 125 may modulate the internal clock signal 111 according to aspects of the present disclosure described above for operation.

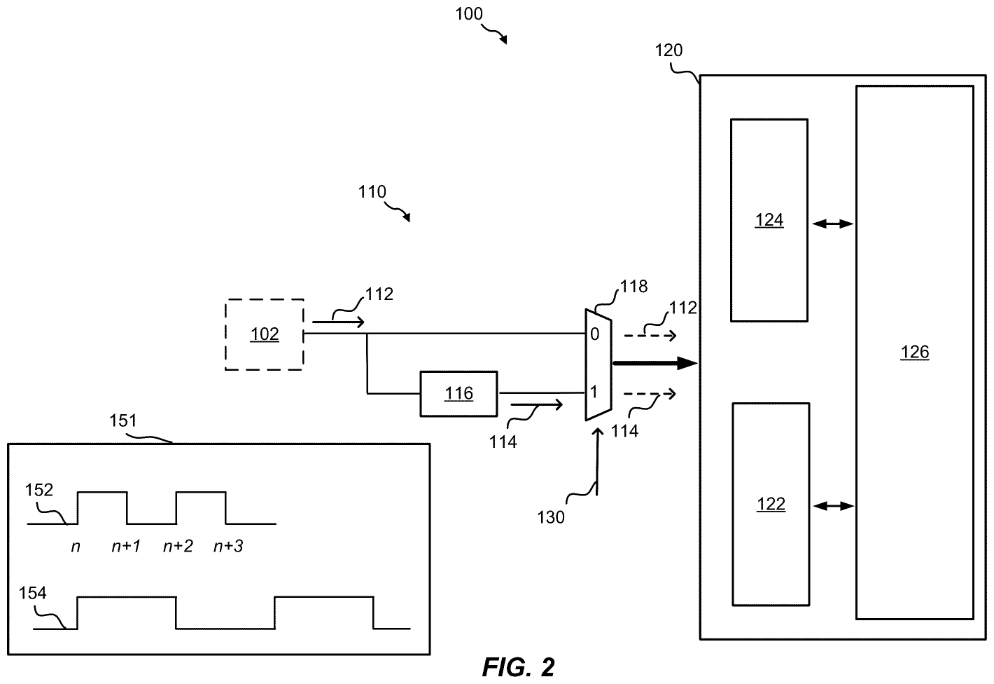

FIG. 2 illustrates another example of the memory circuit 100 according to aspects of the present disclosure. The memory circuit 100 may include an implementation of the timing circuit 110 configured to receive the first clock signal 112 having the first frequency and output the first clock signal 112 and/or the second clock signal 114 having the second frequency. In other words, the timing circuit 110 may selectively output one of the two clock signals. The memory circuit 100 may include an optional clock generator 102 configured to generate the first clock signal 112. In this aspect, the timing circuit 110 includes a frequency divider circuit 116 configured to receive the first clock signal 112 having the first frequency and output the second clock signal 114 having the second frequency. Additionally, in this aspect, the timing circuit 110 includes a switch 118 configured to receive a selection signal 130 to selectively control the output of the first clock signal 112 or the second clock signal 114 to the memory controller 120. For instance, in response to the selection signal 130, the switch 118 is configured to output one of the first clock signal 112 or the second clock signal 114.

During operation, in one aspect of the present disclosure, the clock generator 102 may generate the first clock signal 112 to control read operations with the memory device 126. The frequency divider circuit 116 may receive the first clock signal 112 from the clock generator 102, and may convert the first clock signal 112 having the first frequency to the second clock signal 114 having the second frequency. Specifically, the frequency divider circuit 116 may be a flip-flop, such as a divide-by-two counter. The divide-by-two counter may receive the first clock signal 112, and output the second clock signal 114. In one aspect of the present disclosure, referring to the inset 151 of example clock waveforms, the divide-by-two counter may identify the rising edges (or the falling edges) in the first clock waveform 152. For each rising edge (or each falling edge) of the first clock waveform 152, the divide-by-two counter may output a rising edge (or a falling edge) having half the input frequency to generate the second clock waveform 154. In other words, in this example, for the rising edges n, n+2, . . . , the divide-by-two counter may generate rising edges of the second clock waveform 154 having half the frequency, and for the falling edges n+1, n+3, . . . , the divider-by-two counter may generate falling edges of the second clock waveform 154 having half the frequency. As a result, the divide-by-two counter of the frequency divider circuit 116 may generate the second clock signal 114 having the second clock waveform 154. The second frequency of the second clock signal 114 may be half of the first frequency of the first clock signal 112.

Additionally, in some aspects of the present disclosure, the switch 118 may receive the second clock signal 114 from the frequency divider circuit 116 and the first clock signal 112 from the clock generator 102. The switch 118 may receive the selection signal 130 for selecting one of the first clock signal 112 or the second clock signal 114. In response to the selection signal 130, the switch 118 may transmit the first clock signal 112 to the reading interface 122 of the memory controller 120 or the second clock signal 114 to the programming interface 124 of the memory controller 120.

In one aspect of the present disclosure, the switch 118 may transmit the first clock signal 112 to the reading interface 122 of memory controller 120. The reading interface 122 may use the first clock signal 112 to synchronize, at the first frequency, any reading operation that outputs information from the memory device 126. In some aspects of the disclosure, the memory controller 120 and/or the reading interface 122 may synchronize the reading operation by sampling the rising edge and/or the falling edge of the first clock waveform 152 of the first clock signal 112.

In other aspects of the present disclosure, the switch 118 may transmit the second clock signal 114 to the programming interface 124 of memory controller 120. The programming interface 124 may use the second clock signal 114 to synchronize, at the second frequency, any programming operation that inputs information into the memory device 126. In some aspects of the disclosure, the memory controller 120 and/or the programming interface 124 may synchronize the reading operation by sampling the rising edge and/or the falling edge of the second clock waveform 154 of the second clock signal 114.

One alternative implementation of the memory circuit 100, the clock generator 102 may include separate clock generators, such as a first clock generator configured to generate the first clock signal 112 and a second clock generator configured to generate the second clock signal 114.

In another alternative implementation of the memory circuit 100, the memory controller 120 may include the first interface 122 configured to access a first portion of the memory device 126 and the second interface 124 configured to access a second portion of the memory device 126. The first interface 122 may be configured to operate at a first frequency and the second interface 124 may be configured to operate at a second frequency.

In another alternative implementation of the memory circuit 100, the memory controller 120 may include the first interface 122 configured to perform a first function relating to the memory device and the second interface 124 configured to perform a second function relating of the memory device 126. The first interface 122 may be configured to operate at a first frequency and the second interface 124 may be configured to operate at a second frequency.

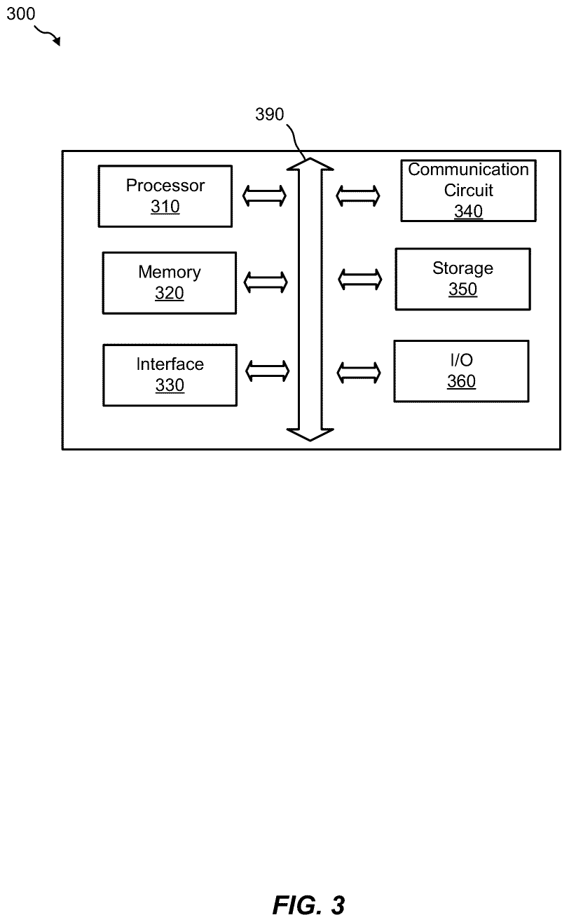

FIG. 3 illustrates an example of a controller 300 for the memory circuit 100. The controller 300 may include some or all of the functions of the memory controller 120 (FIGS. 1 and 2). The controller 300 may be in a single package or as a chip set assembly with multiple components. The controller 300 may include a processor 310 configured to execute instructions stored in a memory 320. The memory 320 may include computer executable instructions. The controller 300 may include an interface circuit 330 configured to provide a hardware interface with external devices. The controller 300 may include a communication circuit 340 configured to communicate via wired or wireless communication channels. The controller 300 may include a storage 350 configured to store digital information. The controller 300 may include an input/output (I/O) interface device 360 configured to receive input signals and/or transmit output signals. The controller 300 may include a bus 390 configured to provide connections among the subcomponents of the controller 300. The memory controller 120 may be implemented as the controller 300, and/or include one or more subcomponents of the controller 300.

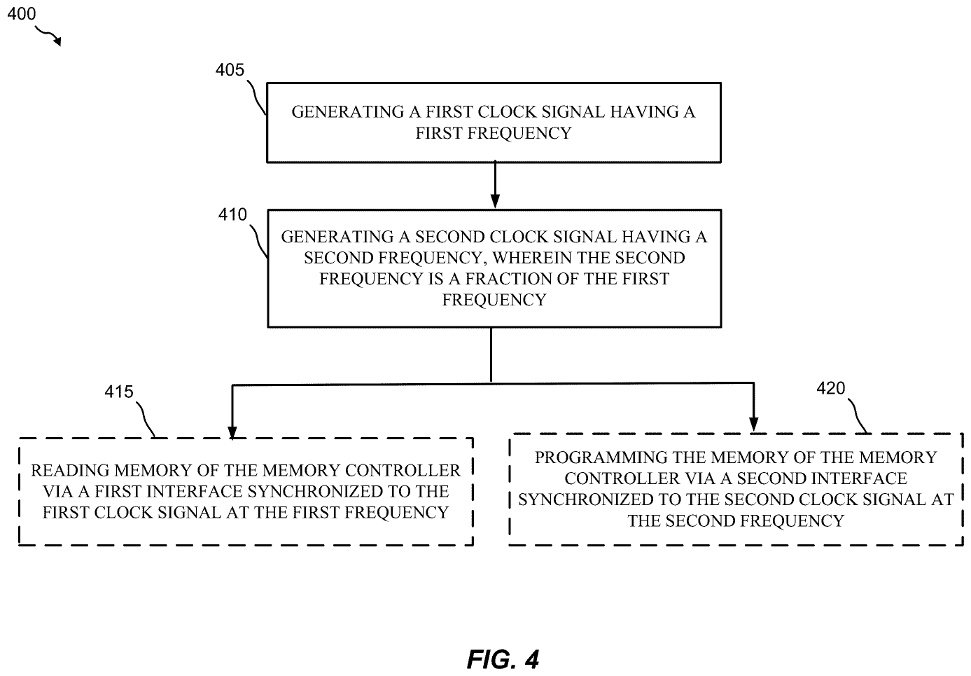

FIG. 4 illustrates an example of a method 400 for operating a memory controller according to aspects of the present disclosure. The method 400 may be performed by the memory circuit 100, the clock generator 102, the timing circuit 110, the memory controller 120, the controller 300, and/or one or more subcomponents of the memory circuit 100, the timing circuit 110, the memory controller 120, and/or the controller 300.

At 405, the method 400 may generate a first clock signal having a first frequency. For example, the timing circuit 110 and/or the clock generator 102 may generate the first clock signal 112 having a first frequency. The timing circuit 110 and/or the clock generator 102 may be configured to, and/or provide means for, generating a first clock signal having a first frequency.

At 410, the method 400 may generate a second clock signal having a second frequency, wherein the second frequency is a fraction of the first frequency. For example, the timing circuit 110 and/or the frequency divider circuit 116 may generate the second clock signal 114 having a second frequency, wherein the second frequency is a fraction of the first frequency. The timing circuit 110 and/or the frequency divider circuit 116 may be configured to, and/or provide means for, generating a second clock signal having a second frequency, wherein the second frequency is a fraction of the first frequency.

At 415, the method 400 may optionally read memory of the memory controller via a first interface synchronized to the first clock signal at the first frequency. For example, the memory controller 120 and/or the controller 300 may read the memory device 126 of the memory controller 120 via the first interface 122 synchronized to the first clock signal 112 at the first frequency. The memory controller 120 and/or the controller 300 may be configured to, and/or provide means for, reading memory of the memory controller via a first interface synchronized to the first clock signal at the first frequency.

At 420, the method 400 may optionally program the memory of the memory controller via a second interface synchronized to the second clock signal at the second frequency. For example, the memory controller 120 and/or the controller 300 may program the memory device 126 of the memory controller 120 via the second interface 124 synchronized to the second clock signal 114 at the second frequency. The memory controller 120 and/or the controller 300 may be configured to, and/or provide means for, programming the memory of the memory controller via a second interface synchronized to the second clock signal at the second frequency.

In summary, implementations of the present disclosure may include one or any combination of the following aspects.

Aspects of the present disclosure include a memory circuit including a timing circuit including a flip-flop configured to receive a clock signal having a first frequency and output an intermediate clock signal having a second frequency that is a fraction of the first frequency, a multiplexer configured to: receive the clock signal and the intermediate clock signal, receive a selection signal indicating a selection of the clock signal or the intermediate clock signal, and output one of the clock signal or the intermediate clock signal based on the selection signal, and a memory controller configured to be read via a first interface synchronized to the clock signal at the first frequency, and programmed via a second interface synchronized to the intermediate clock signal at the second frequency.

Aspects of the present disclosure include a memory circuit having a timing circuit configured to generate an internal clock signal having an internal clock frequency, a modulator configured to adjust a pulse width of the internal clock signal to generate a first clock signal having a first frequency, wherein the first frequency is a fraction of the internal clock frequency, and a memory controller configured to be: read via a first interface synchronized to the internal clock signal at the internal clock frequency, and programmed via a second interface synchronized to the first clock signal at the first frequency.

Aspects of the present disclosure include any of the memory circuits above, wherein the flip-flop is a divide-by-two counter.

Aspects of the present disclosure include any of the memory circuits above, wherein the second frequency is half of the first frequency.

Aspects of the present disclosure include any of the memory circuits above, wherein the memory controller includes one or more of one time programmable memory, flash memory, solid state memory, magnetic memory, field programmable gate array (FPGA), programmable logic array (PLA), random access memory (RAM), read only memory (ROM).

Aspects of the present disclosure include any of the memory circuits above, wherein the memory controller comprises one or more of an Advanced extensible Interface (AXI) or an Advanced Peripheral Bus (APB) interface.

Aspects of the present disclosure include any of the memory circuits above, wherein the first interface is the AXI configured to operate at 125 megahertz (MHz) and the second interface is the APB interface configured to operate at 62.5 MHz.

Aspects of the present disclosure include a method of operating a memory controller including generating a first clock signal having a first frequency, generating a second clock signal having a second frequency, wherein the second frequency is a fraction of the first frequency, and reading memory of the memory controller via a first interface synchronized to the first clock signal at the first frequency, or programming the memory of the memory controller via a second interface synchronized to the second clock signal at the second frequency.

Aspects of the present disclosure include the method above. wherein generating the second clock signal comprises generating the second clock signal using a flip-flop including a divide-by-two counter.

Aspects of the present disclosure include any of the methods above, wherein the second frequency is half of the first frequency.

Aspects of the present disclosure include any of the methods above, wherein the memory is one or more of one time programmable memory, flash memory, solid state memory, magnetic memory, field programmable gate array (FPGA), programmable logic array (PLA), random access memory (RAM), read only memory (ROM).

Aspects of the present disclosure include any of the methods above, wherein the memory controller comprises one or more of an Advanced extensible Interface (AXI) or an Advanced Peripheral Bus (APB) interface.

Aspects of the present disclosure include any of the methods above, wherein the first interface is the AXI operating at 125 megahertz (MHz) and the second interface is the APB interface operating at 62.5 MHZ.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. For example, changes may be made in the function and arrangement of elements discussed without departing from the scope of the disclosure. Also, various examples may omit, substitute, or add various procedures or components as appropriate. For instance, the methods described may be performed in an order different from that described, and various steps may be added, omitted, or combined. Also, features described with respect to some examples may be combined in other examples. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium.

The various illustrative blocks and components described in connection with the disclosure herein may be implemented or performed with a specially-programmed device, such as but not limited to a processor, a digital signal processor (DSP), an ASIC, a FPGA or other programmable logic device, a discrete gate or transistor logic, a discrete hardware component, or any combination thereof designed to perform the functions described herein. A specially-programmed processor may be a microprocessor, but in the alternative, the processor may be any conventional processor, controller, microcontroller, or state machine. A specially-programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above may be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that may be accessed by a general purpose or special purpose computer. By way of example, and not limitation, computer-readable media may comprise RAM, ROM, EEPROM, CD-ROM or other optical disk storage, magnetic disk storage or other magnetic storage devices, or any other medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

What is claimed is:

1. A memory circuit, comprising:
a timing circuit including:
a flip-flop configured to receive a clock signal having a first frequency and output an intermediate clock signal having a second frequency that is a fraction of the first frequency;
a multiplexer configured to:
receive the clock signal and the intermediate clock signal;
receive a selection signal indicating a selection of the clock signal or the intermediate clock signal; and
output one of the clock signal or the intermediate clock signal based on the selection signal; and
a memory controller configured to be:
read via a first interface synchronized to the clock signal at the first frequency; and
programmed via a second interface synchronized to the intermediate clock signal at the second frequency.

2. The memory circuit of claim 1, wherein the flip-flop is a divide-by-two counter.

3. The memory circuit of claim 1, wherein the second frequency is half of the first frequency.

4. The memory circuit of claim 1, wherein the memory controller includes one or more of one time programmable memory, flash memory, solid state memory, magnetic memory, field programmable gate array (FPGA), programmable logic array (PLA), random access memory (RAM), read only memory (ROM).

5. The memory circuit of claim 1, wherein the memory controller comprises one or more of an Advanced extensible Interface (AXI) or an Advanced Peripheral Bus (APB) interface.

6. The memory circuit of claim 5, wherein the first interface is the AXI configured to operate at 125 megahertz (MHz) and the second interface is the APB interface configured to operate at 62.5 MHz.

7. A memory circuit, comprising:
a timing circuit configured to generate an internal clock signal having an internal clock frequency;
a modulator configured to adjust a pulse width of the internal clock signal to generate a first clock signal having a first frequency, wherein the first frequency is a fraction of the internal clock frequency; and
a memory controller configured to be:
read via a first interface synchronized to the internal clock signal at the internal clock frequency; and
programmed via a second interface synchronized to the first clock signal at the first frequency.

8. The memory circuit of claim 7, wherein the first frequency is half of the internal clock frequency.

9. The memory circuit of claim 7, wherein the memory controller includes one or more of one time programmable memory, flash memory, solid state memory, magnetic memory, field programmable gate array (FPGA), programmable logic array (PLA), random access memory (RAM), read only memory (ROM).

10. The memory circuit of claim 7, wherein the memory controller comprises one or more of an Advanced extensible Interface (AXI) or an Advanced Peripheral Bus (APB) interface.

11. The memory circuit of claim 10, wherein the first interface is the AXI configured to operate at 125 megahertz (MHz) and the second interface is the APB interface configured to operate at 62.5 MHz.

12. A method of operating a memory controller, comprising:
generating a first clock signal having a first frequency;
generating a second clock signal having a second frequency, wherein the second frequency is a fraction of the first frequency; and
reading memory of the memory controller via a first interface synchronized to the first clock signal at the first frequency; or
programming the memory of the memory controller via a second interface synchronized to the second clock signal at the second frequency.

13. The method of claim 12, wherein generating the second clock signal comprises generating the second clock signal using a flip-flop including a divide-by-two counter.

14. The method of claim 12, wherein the second frequency is half of the first frequency.

15. The method of claim 12, wherein the memory is one or more of one time programmable memory, flash memory, solid state memory, magnetic memory, field programmable gate array (FPGA), programmable logic array (PLA), random access memory (RAM), read only memory (ROM).

16. The method of claim 12, wherein the memory controller comprises one or more of an Advanced extensible Interface (AXI) or an Advanced Peripheral Bus (APB) interface.

17. The method of claim 16, wherein the first interface is the AXI operating at 125 megahertz (MHz) and the second interface is the APB interface operating at 62.5MHz.
